(19) United States
(12) Patent Application Publication
(10) Pub. No.: US 2003/0150315 A1
(43) Pub. Date: Aug. 14, 2003

(54) Cam gear punch

(76) Inventor: Li-Chen Lin, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/068,899

(22) Filed: Feb. 11, 2002

(51) Int. Cl. B26D 1/06

(52) U.S. Cl. 83/628; 83/629

(57) ABSTRACT

A cam gear punch has a simple structure and is capable of slowing down punching space and accelerating punching pressure. The punch has a punch mainframe which includes a motor to drive a transmission cam gear. The transmission cam gear engages with a driven cam gear which is mounted on a transmission shaft. The transmission shaft has one end pivotally mounting in the punch mainframe and another end coupling with the driven cam gear. An eccentric transmission wheel is mounted on the transmission shaft. The eccentric transmission wheel has one end engaging with a slide block. The transmission cam gear and

driven cam gear are formed in irregular shapes such that when the transmission cam gear drives the drive cam gear to rotate synchronously, the eccentric transmission wheel may be moved in a multi-stage fashion at different speeds.

### BACKGROUND OF THE INVENTION

1. Field of the Invention

The invention relates to a cam gear punch and particularly to a cam gear punch that is simply structured and allows to slow down punching space and accelerate punching pressure.

2. Description of the Prior Art

Operations of punches can be generally categorized in “straight axle type” and “toggle type”. The “straight axle type” operation is directly moving down vertically, and through the moving down force and the driving force of the original generating force presses the punching object in a short period of time. It gives the punching object maximum punching pressure to form a product desired. As the straight axle type operation has excessive punch pressure, it often results in defected products. The “toggle type” operation utilizes toggle linkage bars to overcome the disadvantages of excessive speed and punching pressure of the straight axle type operation. However the slower moving down speed of the toggle type operation often results in not adequate punching pressure, and also causes high defective rates on the finished products.

To resolve the foregoing problems, there is a “Linkage type punch” being developed (as shown in FIG. 7). It operates through an eccentric shaft located at a selected position on the displacement, and slows down linear acceleration of punching operations without changing punching pressure to achieve even distribution of punching pressure. It mainly includes a punch mainframe 60 in which power is transmitted from a motor 610 to an eccentric transmission gear 611. The eccentric transmission gear 611 is coupled with an eccentric linkage bar 612 which is driven to operate eccentrically by the eccentric transmission gear 611. The eccentric linkage bar 612 has one end pivotally connecting an upper end of a toggle lower linkage bar 620 which is operated synchronously with the eccentric linkage bar 612. The toggle lower linkage bar 620 has a lower end connecting a slide block 650. There is a toggle upper linkage bar 630 which has one end connecting the one end of the eccentric linkage bar 612 where the toggle lower linkage bar 620 is connected. Hence the eccentric linkage bar 612, the toggle lower linkage bar 620 and the toggle upper linkage bar 630 can be moved relatively to one another. The toggle upper linkage bar 630 has another end coupling with a round crank transmission bar 632 which is mounted on a crank transmission shaft 640 on the eccentric axis of the crank transmission bar 632. The crank transmission shaft 640 has one end attached to a crank transmission gear 631 which is engaged with the eccentric transmission gear 611. When the motor 610 drives the eccentric linkage bar 612 operating, the crank transmission shaft 640 drives the crank transmission bar 632 to rotate eccentrically, thereby punching linear acceleration of the toggle lower linkage bar 620 is reduced. As a result, the punching operations have three-stage speed variations, i.e. descending at a high speed, increasing pressure at a low speed and returning at a high speed (referring to curve S2 in FIG. 6). Thus product quality can be improved. Although the “Linkage type punch” can improve the operation disadvantages incurred to the “toggle type” punches, conventional linkage type punches 60 still have the drawbacks, notably complex structures, difficult to assemble, repair and maintain, and higher costs.

### SUMMARY OF THE INVENTION

In view of aforesaid disadvantages, the invention aims to provide an improved punch that has a simple structure to facilitate assembly, repairs and maintenance. The “cam gear type punch” of the invention mainly employs a transmission cam gear to drive a driven cam gear, and through the non-circular transmission cam gear and driven cam gear to allow the driven cam gear having multiple stages moving variations. Consequently, a coupled eccentric transmission wheel also is driven with multiple stages moving variations at different speeds. Assembly is easier, and repairs and maintenance are simpler. Costs are lowered and defected products can be reduced.

Therefore the primary object of the invention is to provide a cam gear type punch that has a simple structure and multiple stages speed variations during punching operations to ensure production quality.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the invention.

FIG. 2 is a fragmentary schematic view of the invention in an operating condition.

FIG. 3 is a fragmentary schematic view of the invention in another operating condition.

FIG. 4 is a fragmentary schematic view of the invention in yet another operating condition.

FIG. 5 is a schematic view of displacement variations of an eccentric transmission wheel of the invention.

FIG. 6 is a slide block displacement curve chart of the invention and a conventional linkage punch.

FIG. 7 is a schematic view of a conventional linkage punch.

### DESCRIPTION OF THE PREFERRED EMBODIMENT

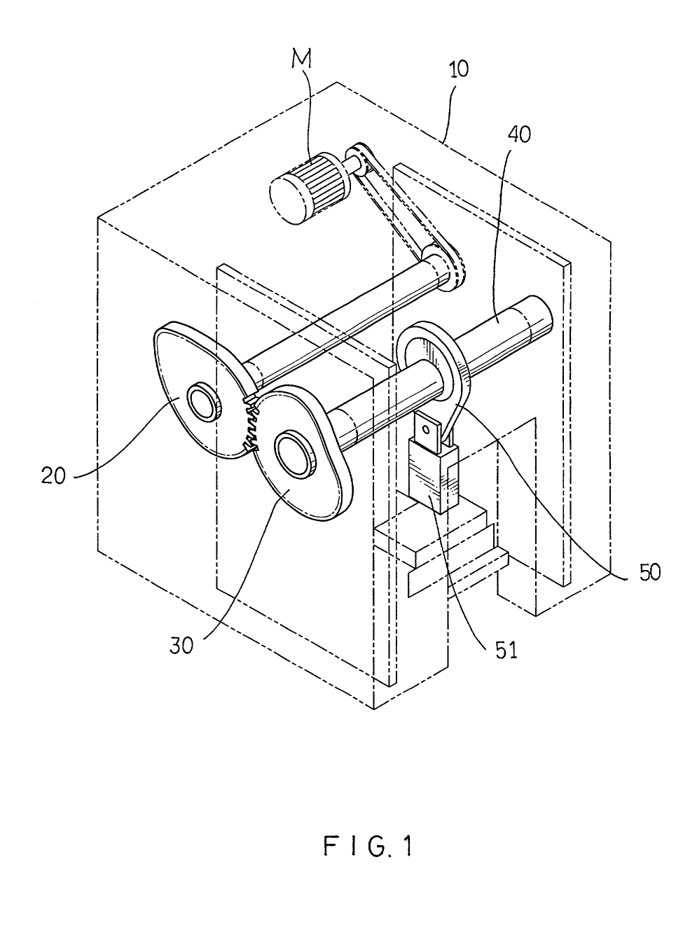

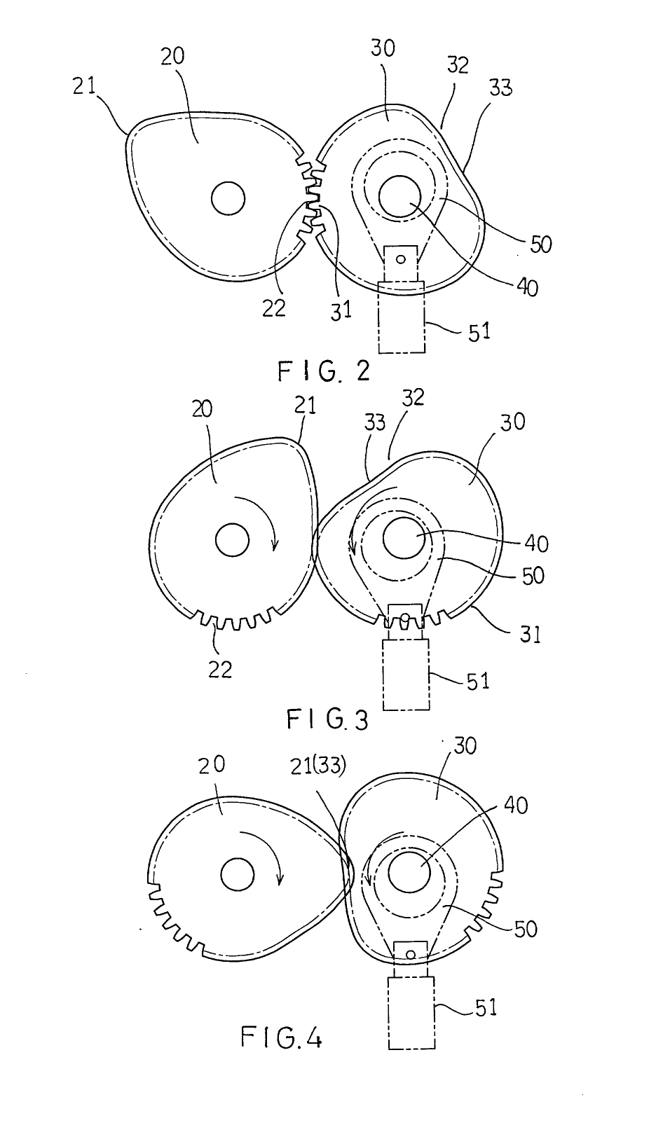

Referring to FIGS. 1 and 2, the cam gear type punch of the invention mainly includes a punch mainframe 10 which has a motor M, a transmission cam gear 20, a driven cam gear 30, a transmission shaft 40 and an eccentric transmission wheel 50. The transmission cam gear 20 is driven by the motor M to rotate. The transmission cam gear 20 engages with the driven cam gear 30. The transmission shaft 40 has one end pivotally mounting in the punch mainframe 10 and another end pivotally engaging with the driven cam gear 30. The eccentric transmission wheel 50 is coupled with the transmission shaft 40 and has one end pivotally engaging with a slide block 51.

The transmission cam gear 20 is formed substantially in an oval shape and has a pinnacle point 21 on the peripheral rim thereof with a maximum distance from the axis of the transmission cam gear 20 and a first lowest point 22 on the peripheral rim.

The driven cam gear 30 is a gear of an irregular shape with one peripheral side formed an curved section 31 and another peripheral side formed an arched section 32 which has a second lowest point 33 located thereon.

When the motor M is activated and drives the transmission cam gear 20 rotating, the driven cam gear 30 is also driven and rotates. As the transmission cam gear 20 and the driven cam gear 30 are non-circular gears, rotation transmission from the transmission cam gear 20 to the driven cam gear 30 generates a multiple-stage moving variations on the driven cam gear 30. Consequently, the transmission shaft 40 and the eccentric transmission wheel 50 mounted on the transmission shaft 40 also are driven to rotate. As the transmission shaft 40 is driven by the driven cam gear 30, the eccentric transmission wheel 50 also is moved in a multiple-stage fashion at different speeds. The operations can be divided in three stages as follows:

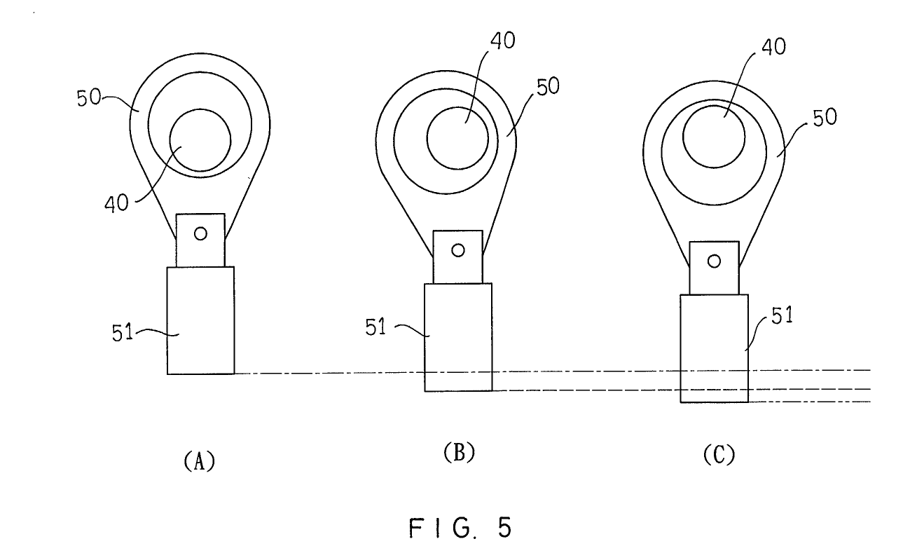

1. Before activation, the first lowest point 22 of the transmission cam gear 20 engages with the curved section 31 of the driven cam gear 30, and the eccentric transmission wheel 50 is located at a high point (as shown in FIG. 2). When the motor M rotates and drives the transmission cam gear 20 to rotate, the driven cam gear 30 also is driven to rotate. The driven cam gear 30 is driven at the outer periphery of the curved section 31, and indirectly drives the eccentric transmission wheel 50 rotating. Consequently the eccentric transmission wheel 50 is moved downwards at a steady speed (as shown in FIG. 3, and referring to FIGS. 5A and B for moving down variations).

2. When the transmission cam gear 20 rotates continuously, because of the driven cam gear 30 subjects to traction of the transmission cam gear 20, and the transmission cam gear 20 engages with the driven cam gear 30 at the pinnacle point 21 and the second lowest point 33 As the arched section 32 of the driven cam gear 30 has smaller displacement variations from its one end to the second lowest point 33 (located at the middle portion, as shown in FIG. 4), hence the eccentric transmission wheel 50 also subjects to the rotational variations of the driven cam gear 30 and is moved downwards vertically at a faster speed (as shown in FIGS. 5B and 5C). Thus the slide block 51 may be descended at a faster speed in a shorter distance to punch the punching object with a desired punching force.

3. After punching operations have completed, the transmission cam gear 20 rotates continuously, and the driven cam gear 30 is driven and engages with the transmission cam gear 20 in the curved section 31. The eccentric transmission wheel 50 may be moved upwards at a slower speed to a punch standby condition (as shown in FIG. 2, motion variations are shown in FIGS. 5C and 5A).

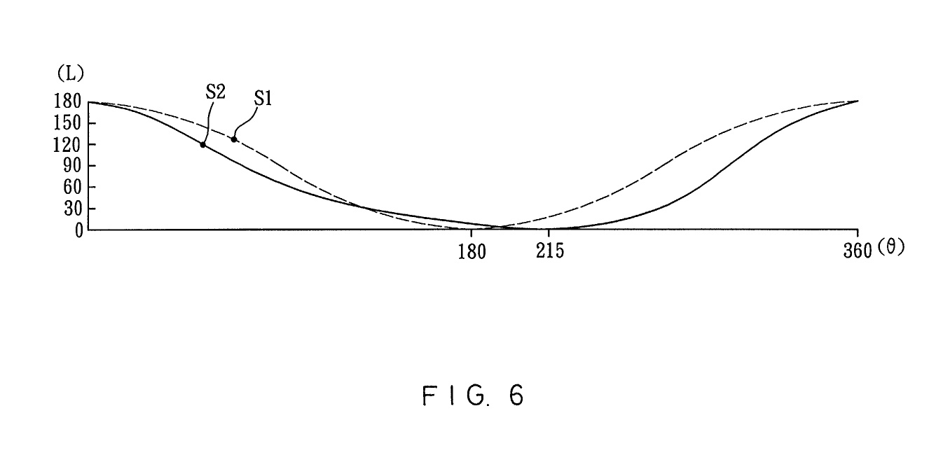

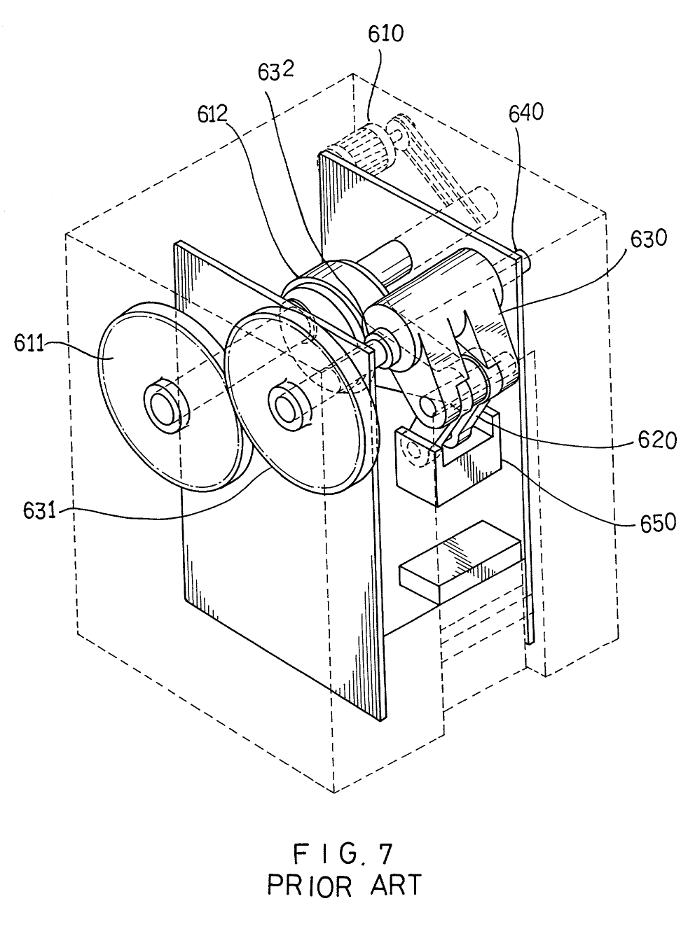

Referring to FIG. 6 for a slide block displacement chart of the invention and a conventional cam gear type punch (with the S1 curve representing the slide block displacement of the invention, and the S2 curve representing the conventional slide block displacement. The horizontal coordinate represents angle of the slide block, and the vertical coordinate represents the elevation of the slide block). Comparing the invention with the conventional technique, the invention provides steadier descending speeds, drops downwards vertically at faster speeds, and moves upwards at slower speeds. The invention thus can produce products with higher and consistent quality than conventional techniques.

In summary, the invention offers a simple structure and can operate at different speeds. Moreover, it provides convenient assembly, simpler repairs and maintenance, lower costs and less defective products.

While the preferred embodiment of the invention has been set forth for the purpose of disclosure, modifications of the disclosed embodiment of the invention as well as other embodiment thereof may occur to those skilled in the art. Accordingly, the appended claims are intended to cover all embodiments which do not depart from the spirit and scope of the invention.

I claim:

1. A cam gear punch having a punch mainframe comprising:
a motor;
a transmission cam gear driven by the motor;
a driven cam gear engaging with the transmission cam gear;
a transmission shaft having one end pivotally mounting in the punch mainframe and another end coupling with the driven cam gear; and
an eccentric transmission wheel mounting on the transmission shaft and having one end pivotally engaged with a slide block;
wherein the transmission cam gear and the driven cam gear are formed in irregular shapes, the driven cam gear being driven by the transmission cam gear to rotate synchronously and in turn driving the eccentric transmission wheel moving in a multi-stage fashion at different speeds.

2. The cam gear punch of claim 1, wherein
the transmission cam gear is formed substantially in an oval shape having a pinnacle point formed on the peripheral rim thereof with a maximum distance from the axis of the transmission cam gear and a first lowest point on the peripheral rim; and
the driven cam gear has a peripheral side forming a curved section and another peripheral side forming an arched section which has a second lowest point located thereon.
